(19) United States
(12) Patent Application Publication
(10) Pub. No.: US 2026/0006277 A1
(43) Pub. Date: Jan. 1, 2026

(54) DIGITAL MEDIA DEVICE/MEDIA PLAYING SYSTEM WITH A DECORATIVE ENCASING

(71) Applicants: Dharmesh Dhimant Bhatt, Bridgewater, NJ (US); Kala Dharmesh Bhatt, Bridgewater, NJ (US); Sahil Dharmesh Bhatt, Bridgewater, NJ (US); Shrey Dharmesh Bhatt, Bridgewater, NJ (US)

(72) Inventors: Dharmesh Dhimant Bhatt, Bridgewater, NJ (US); Kala Dharmesh Bhatt, Bridgewater, NJ (US); Sahil Dharmesh Bhatt, Bridgewater, NJ (US); Shrey Dharmesh Bhatt, Bridgewater, NJ (US)

(21) Appl. No.: 19/246,272

(22) Filed: Jun. 23, 2025

Related U.S. Application Data
(60) Provisional application No. 63/662,517, filed on Jun. 21, 2024.
(60) Provisional application No. 63/682,068, filed on Aug. 12, 2024.

(51) Int. Cl. H04N 21/414; G06F 1/16; G06F 1/3203

(52) U.S. Cl. CPC H04N 21/41407; G06F 1/1613; G06F 1/3203

(57) ABSTRACT

A digital media device comprising non-volatile memory comprising media content, volatile memory, a wireless communication interface, power source, a decorative encasing with decorative element(s) that symbolizes the media content, operating system configured for media playback, and processing circuitry. And a media-playing system comprising the device.

### TECHNICAL FIELD

This disclosure relates generally to media-playing consumer electronic devices and systems.

### BACKGROUND

Consumer electronic devices arrive on the market with some frequency, to the delight of the users. More, however, are needed.

### SUMMARY

In one aspect, this disclosure provides a digital media device comprising non-volatile memory comprising media content, volatile memory, a wireless communication interface, power source, a decorative encasing with decorative element(s) that symbolizes the media content, operating system configured for media playback, and processing circuitry.

In another aspect, this disclosure provides a media-playing system comprising a disclosed digital media device.

Numerous other aspects are provided in accordance with these and other aspects of the invention. Other features and aspects of the present invention will become more fully apparent from the following detailed description and the appended claims.

### BRIEF DESCRIPTION OF THE DRAWINGS

FIG. 1 shows an embodiment of the disclosed device.

### DETAILED DESCRIPTION

As used herein, the word “a” or “plurality” before a noun represents one or more of the particular noun.

For the terms “for example,” “such as,” “including,” and grammatical equivalences thereof, the phrase “and without limitation” is understood to follow unless explicitly stated otherwise. As used herein, the term “about” is meant to account for variations due to experimental error. All measurements reported herein are understood to be modified by the term “about,” whether or not the term is explicitly used, unless explicitly stated otherwise. As used herein, the singular forms “a,” “an,” and “the” include plural referents unless the context clearly dictates otherwise.

All ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should be considered to include the end points 5 and 10.

It is further to be understood that the feature or features of one embodiment may generally be applied to other embodiments, even though not specifically described or illustrated in such other embodiments, unless expressly prohibited by this disclosure or the nature of the relevant embodiments. Likewise, compositions and methods described herein can include any combination of features and/or steps described herein not inconsistent with the objectives of the present disclosure. Numerous modifications and/or adaptations of the compositions and methods described herein will be readily apparent to those skilled in the art without departing from the present subject matter.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, controls.

In one aspect, this disclosure provides a digital media device comprising: non-volatile memory comprising media content; volatile memory; a wireless communication interface; power source; a decorative encasing with decorative element(s) that symbolizes the media content; operating system configured for media playback; and processing circuitry.

In certain embodiments, the non-volatile memory comprising media content is a storage drive, a solid state drive, a flash drive, embedded storage, or any other suitable non-volatile memory.

In some embodiments, the volatile memory is dynamic random-access memory, static random-access memory, synchronous dynamic random-access memory, or any other suitable volatile memory.

In some embodiments, processing circuitry is used for controlling various functions, including operating system management, executing software applications, and device connectivity. The processing circuitry is implemented using any variety of processing technology. In some embodiments, the processing circuitry includes one or more processors, such as a central processing unit (CPU), a graphics processing unit (GPU), or a microcontroller (MCU). In other embodiments, the processing circuitry is implemented as a System on a Chip (SoC), an Application-Specific Integrated Circuit (ASIC), or a Field-Programmable Gate Array (FPGA). The processing circuitry comprises any suitable processor(s).

The wireless communication interface is configured to operate according to one or more suitable wireless communication standards. In some embodiments, the wireless communication interface comprises Bluetooth transceiver or a Near Field Communication (NFC) interface. In other embodiments, the wireless communication interface comprises a radio interface, such as cellular communication interface or broadcast radio receiver. In other embodiments, the wireless communication interface comprises a wireless local area network (WLAN) interface, such as a Wi-Fi transceiver. In some embodiments, the wireless communication interface is further configured to implement various application-layer protocols, including proprietary protocols like AirPlay. In some embodiments, the device further comprises a wired data interface configured to communicatively couple the device to an external device.

In some embodiments, the device comprises a power source and a power management system. In some embodiments, the power source is rechargeable, and the power management system is configured to recharge the power source by receiving power through any variety of charging interfaces, including a conductive charging interface or a wireless power receiver. In some embodiments, the power source comprises one or more disposable batteries and a power compartment with electrical contacts, configured to removably receive the disposable batteries.

The disclosed digital media device has a decorative encasing with decorative element(s). In some embodiments, the decorative encasing has decorative element(s) that symbolizes the media content. In some embodiments, the device comprises one or more transparent or translucent or colored faces. In some embodiments, the decorative encasing comprises an inner diorama as decorative element. In some embodiments, the inner diorama is displayed on one or more transparent or translucent or colored faces of the device. In some embodiments, the inner diorama symbolizes the media content. In further embodiments, the decorative element(s) includes lights, modular and transformable elements, figurines, and physical controls.

The media content comprises any form of media, including audio, text-based, visual, interactive, mixed, etc.

In some embodiments, the device further comprises an audio output system configured to render audio from the media content. In certain embodiments, the audio output system is configured for one or both internal playback and external playback. For internal playback, in certain embodiments, the audio output system comprises one or more integrated acoustic transducers for converting an electrical audio signal into audible sound directly from the device. For external playback, in certain embodiments, the audio output system comprises an audio output interface configured to transmit the audio signal to a separate playback device via wireless or wired connections.

In some embodiments, at least one surface of the device comprises at least one interactive display system for various user presentation and facilitation functions, including graphical user interface, executing first or third-party software applications, displaying visual media content, or establishing a data connection with external devices to exchange information. In certain embodiments, the display system is movably coupled to the device's housing via an adjustable mechanism. This mechanism allows the display system to be physically repositioned, for example, by raising, lowering, tilting, or swiveling the display to accommodate a user's viewing angle or preference.

In some embodiments, the device comprises personalized media content uploaded by a user that plays independently or in accordance with pre-loaded media content, personalized diorama with design contributions from the user, or both.

In some embodiments, the device includes an operating system. In certain embodiments, the operating system and processing circuitry execute a plurality of software applications. In certain embodiments, the software applications is first-party applications provided by the device manufacturer or third-party applications obtained from an application marketplace or external developers. These software applications provide a wide range of functionalities, including entertainment, social interaction, or productivity. In some embodiments, the device comprises software for web browsing application, enabling a user to access, retrieve, and display content from the internet. In some embodiments, the device comprises software for informational applications, including calendar, clock, or calculator, or environmental data. In some embodiments, the device comprises software for karaoke configured to present lyrics synced with audio tracks. In further embodiments, the device comprises software for user customization of pre-loaded media content and user customization of pre-loaded media content through integrating personally uploaded media content. In some embodiments, the device comprises software configured to project two-dimensional content or three-dimensional holographic display on one or more of the device's faces. In some embodiments, the device comprises a smart home control module configured to interoperate with external smart home devices via wireless communication. In some embodiments, the device comprises a data synchronization module configured to establish a communication link between multiple devices.

In certain embodiments, the device comprises software for a gaming application, including musical game(s), party game(s), or classic board and card games such as chess, checkers, solitaire. In further embodiments, the game is played by multiple users on multiple devices. In some embodiments, the device is configured to function as a central hub that interoperates with one or more peripheral components to facilitate an interactive experience. In certain embodiments, these peripheral components are physical objects associated with a software application running on the device. In certain embodiments, such components includes interactive game pieces, playing cards, tokens, or modular game boards. In certain embodiments, the device is configured to recognize the identity, position, status, or other attributes of the peripheral components through various means, including wireless short-range communication, optical recognition via device cameras or sensors, or conductive or capacitive sensing.

In some embodiments, the device further comprises a music education and analysis software suite. This suite, in some embodiments, is configured to provide users with tools for learning music theory, analyzing audio content, and receiving instruction for playing musical instruments. In some embodiments, the suite includes one or more of the following modules: a real-time music analysis module configured to process an audio stream and identify musical properties such as lyrics, notes, corresponding octaves, chord progressions. In some embodiments, the suite includes interactive instrument tutor module that provides lessons and real-time feedback to assist a user learning to play a new instrument.

In some embodiments, the device further comprises a spatial computing system configured to generate a mixed reality environment that blends virtual content with a user's physical environment. The spatial computing system includes necessary hardware and software, such as a sensor suite, a display system, specialized processing circuitry, and software modules. The display system is configured to present mixed reality environments to the user by any variety of means, including an integrated display system integrated directly into the housing of the device or an external head-mounted display system or eye-wearable that supports multi-modal communication with the device.

In some embodiments, the device further comprises a fluid reservoir and dispensing system. The reservoir is configured to contain a fluid and the dispensing mechanism is operatively coupled to the reservoir and is configured to dispense the fluid. The dispensing system comprises any variety of mechanisms, including a pump, an atomizer, or a sprayer. The fluid can be any of a variety of compositions, including mist, fragrance, or disinfectant.

In some embodiments, the device comprises a physical coupling system configured to secure the device mechanically to other objects, including inter-device coupling in which the device is mechanically coupled to another disclosed device by any variety of means, including magnetic coupling or mechanical interlock; environmental mounting in which the device further comprises a mounting interface configured to facilitate securing the device to an external support structure or object, such as a wall or bike, by any variety of mounting methods.

In some embodiments, the device further comprises a locomotion and motion system configured to physically move, and in further embodiments, under the control of a user via a remote command/control. In certain embodiments, the system includes one or more of the following subsystems: an actuator system enabling the device to hover, to shake, or to otherwise move, an ariel locomotion system enabling the device to fly, a terrestrial locomotion system enabling movement across a surface. In some embodiments, the remote control communicates with the device by any variety of control systems including a wireless communication interface, such as Bluetooth and radio, or a wired data interface.

In certain embodiments, the device comprises ruggedized and sealed housing to ensure operational integrity in various environmental conditions. In certain embodiments, the housing and its components is configured to provide resistance to various environmental conditions including liquid and particulate ingress, physical shock, and thermal stress.

In some embodiments, the device further comprises an audio production system configured to enable the recording, editing, and mixing of high-fidelity audio from a variety of sources, including direct input from microphones and musical instruments. In certain embodiments, the system includes an audio input interface configured to receive and digitize audio signals from external sources, including physical input connectors, microphone and instrument preamplifiers, and analog-to-digital converters. In certain embodiments, the system also includes specialized software, such as a digital audio workstation to provide user with audio editing and recording tools.

In some embodiments, the device is assembled from individual parts. This disclosure also provides a kit comprising individual parts of a disclosed device for assembling into a disclosed device.

In some embodiments, the device further comprises an environmental effects system configured to manipulate an internal environment of the device. In certain embodiments, the environmental effects system includes a fluid dynamics module, including a propeller or impeller, operable to generate movement within a fluid medium; a luminous discharge element configured to produce transient spark effects; a gaseous effects module configured to generate and disperse vapor, fog, or bubbles; a liquid effects module configured to simulate environmental phenomena including waves, waterfalls, and precipitation; a mechatronic system for imparting controlled motion, including rotation, translation, or oscillation, to one or more decorative elements. In further embodiments, the environmental effects system is configured to receive user commands via a remote control or software application.

In some embodiments, the device comprises an imaging system. In certain embodiments, the imaging system is configured to capture digital still images, record video, and enable real-time video communication with external devices or between multiple disclosed devices. In certain embodiments, the imaging system includes a combination of hardware components and software modules. In certain embodiments, the hardware components includes an image sensor, an optical assembly comprising one or more lenses and an autofocus mechanism, an Image Signal Processor (ISP) for processing raw sensor data, and/or a light source. In certain embodiments, the Software modules, executed by the device's processing circuitry, is configured to control the hardware components to capture images and record video. In certain embodiments, the software is further configured to enable real-time video communication or a computer vision module to analyze image or video data to identify content therein. In certain embodiments, such analysis includes object detection, facial recognition, scene recognition, and Optical Character Recognition (OCR).

In some embodiments, the device includes one or more systems for advanced computation. In certain embodiments, the systems comprises specialized hardware and software modules for implementing functionalities related to artificial intelligence (AI). In certain embodiments, the device includes an AI system configured to perform tasks including generative AI for creating novel content powered by one or more generative models, agentic AI to operate as a semi-autonomous agent capable of chain of thought and sequential reasoning, and/or physical AI communicatively coupled to control the device's physical hardware.

In some embodiments, the device comprises specialized hardware and software modules for implementing functionalities related to machine learning (ML). In certain embodiments, the device includes a ML system supporting one or more pre-trained machine learning models or a framework for training new models on the device. In certain embodiments, this system includes defined neural network architectures, training algorithms, and/or access to one or more training or inference data sets.

In some embodiments, the device comprises specialized hardware and software modules for implementing functionalities relating to quantum computing. In certain embodiments, the device includes a quantum computing system for solving problems intractable for classical computers. This system includes quantum processing hardware like quantum processing unit, qubits of various physical modalities, a cryogenic cooling system, and software components like quantum algorithms and quantum programming language.

In certain embodiments, the device functions as a node in a blockchain or Distributed Ledger Technology (DLT) network. In some embodiments, the hardware includes processing circuitry configured for efficient cryptographic hashing and a network interface for participating in a peer-to-peer network. In some embodiments, the software components includes a consensus mechanism, a local copy of the distributed ledger, and the capability to create, validate, and execute smart contracts or other decentralized applications.

In another aspect, this disclosure provides a media-playing system comprising a disclosed digital media device.

In some embodiments, the system further comprises a remote control device configured to control the functions of the digital media device. In some embodiments, the remote control device comprises an ergonomic housing containing its own processing circuitry and power source. In some embodiments, the remote control device further includes a plurality of user input, output, and communication systems, including a set of high-precision analog controls, a high-fidelity motion sensing system, audio input and output system, one or more touch-sensitive surfaces, haptic feedback system, and multi-modal communication interface. In some embodiments, the remote control device communicates with the disclosed digital media device by any variety of control systems including a wireless communication interface, such as Bluetooth and radio, or a wired data interface.

In some embodiments, the system comprising the disclosed device further comprises one or more of: snow globe technology; headphones/earphones; stuffed animal; portable/handheld Fan/heater; shower head; toothbrush/electric tooth brush; air freshener; candle holder; tissue box; pen/pencil; portable charger/wireless charger; phone case; headphone/earphone case; musical instrument; cassette; CD player, record player, and/or cassette player; picture frame; table top fire places; keychain; handbag; any light structure (such as lamp, light bulb, night light, flash light, etc.); a ball (such as basketball, football, etc.); a toy gun (such as water gun, gel blaster gun, etc.); amirror (such as vanity mirror, decorative mirror, framed mirror, etc.), a hand wearable (such as wrist wearable, finger wearable, etc.); a case or storage (such as jewelry box, pencil case, glasses case, etc.); candy dispenser/gum ball machine; shoes; clothing (such as shirts, pants, etc.); personal care tools (such as grooming utensils, makeup products, etc.); bound volume (such as book, journal, etc.); lighter; ash tray; planter; any bottle opener (such as traditional, cork screw, speed, etc.); jewelry (such as ring, earrings, etc.), neck wearable; any head or eye wearable; any kitchen appliance (such as oven, beverage maker, refrigerator, etc.); any kitchenware (such as cookware, cutlery, tableware, etc.); and/or any liquid-storing glass/container (such as cup/mug, decanter, shot glasses, etc.). These can be any known in the art and be made of any suitable material and be of any suitable size and shape.

In some embodiments, the system comprising the disclosed device comprises the disclosed device and any embodiments of the device in which a component is separated or separable from the device.

The components of the disclosed device and disclosed system are known in the art. The necessary software are known in the art and can be generated by one of ordinary skill in the art.

The disclosed device and components of the disclosed system is of any suitable dimension and suitable shape. The disclosed device and components of the disclosed system is made of any suitable materials, by ways known in the art.

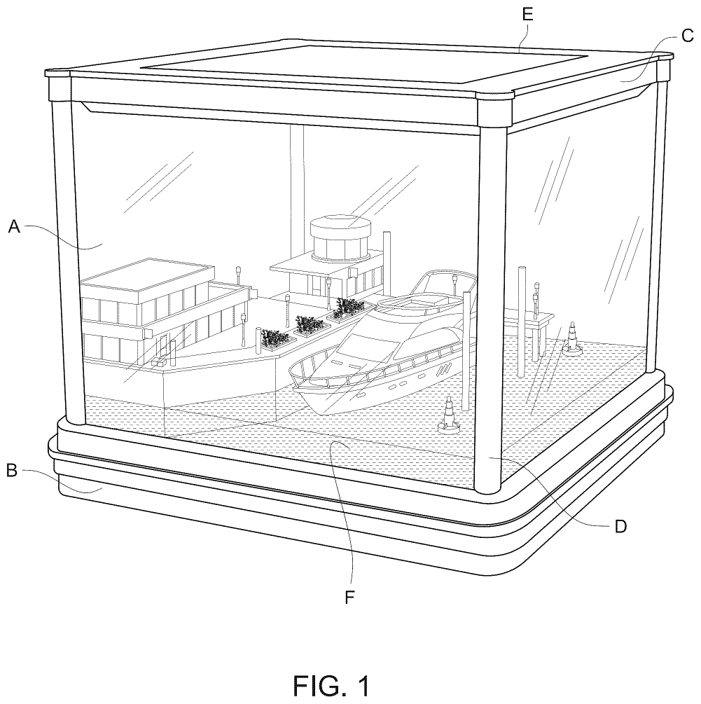

An exemplary embodiment of the disclosed device is shown in FIG. 1. (A) is the encasing of the device, which in this embodiment is a 9 cm×9 cm×9 cm plastic cube, with four transparent lateral faces. (B) is the bottom platform, which in this embodiment is a 9 cm×9 cm×1 cm frosted plastic rectangular prism and which internally houses circuitry board, power source, and associated components. (C) is the top platform, which in this embodiment is a 9 cm×9 cm×1 cm frosted plastic rectangular prism and which internally houses circuitry components. (D) shows frosted columns for the 4 lateral edges, internally houses circuitry to connect components of the top and bottom platforms. (E) is a screen with programmatic controls capable of wireless recognition and connection to external devices, basic media control functions, app compatibility, and visual elements. (F) is an inner diorama with decorative elements, such as lights and figurines, that physically symbolize the auditory content.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the appended claims. Thus, while only certain features of the invention have been illustrated and described, many modifications and changes will occur to those skilled in the art. It is therefore to be understood that the appended claims are intended to cover all such modifications and changes as fall within the true spirit of the invention.

1. A digital media device comprising non-volatile memory comprising media content; volatile memory; a wireless communication interface; power source; a decorative encasing with decorative element(s) that symbolizes the media content; operating system configured for media playback; and processing circuitry.

2. The device of claim 1, wherein the non-volatile memory comprising media content is a storage drive, a solid state drive, a flash drive, or embedded storage.

3. The device of claim 1, wherein the volatile memory is dynamic random-access memory, static random-access memory, or synchronous dynamic random-access memory.

4. The device of claim 1, further comprising a power source and a power management system.

5. The device of claim 1, wherein the device comprises one or more transparent or translucent or colored faces.

6. The device of claim 1, wherein the decorative encasing comprises an inner diorama as decorative element.

7. The device of claim 6, wherein the inner diorama is displayed on said one or more transparent or translucent or colored faces.

8. The device of claim 1, wherein the decorative element(s) includes lights, modular and transformable elements, figurines, and/or physical controls.

9. The device of claim 1, further comprising an audio output system configured to render audio from the media content.

10. The device of claim 9, wherein the audio output system is configured for one or both internal playback and external playback.

11-15. (canceled)

16. The device of claim 1, further comprising personalized media content uploaded by a user that plays independently or in accordance with pre-loaded media content, personalized diorama with design contributions from the user, or both.

17. The device of claim 1, further comprising an operating system, which along with the processing circuitry, are configured to execute a plurality of software applications.

18. The device of claim 1, further comprising software applications providing entertainment, social interaction, and/or productivity.

19. The device of claim 18, comprising one or more software applications software applications for web browsing application, for informational applications, for karaoke, for user customization of pre-loaded media content and user customization of pre-loaded media content through integrating personally uploaded media content, software configured to project two-dimensional content or three-dimensional holographic display on one or more of the device's faces.

20-21. (canceled)

22. The device of claim 1, comprising software and hardware components for a gaming application.

23-35. (canceled)

36. The device of claim 1, wherein the device is assembled from individual parts.

37. A kit comprising individual parts of a device of claim 36.

38. A media-playing system comprising a digital media device of claim 1.

39. The system of claim 38, further comprising a remote control device configured to control the functions of the digital media device.

40. The system of claim 38, further comprising one or more of: snow globe technology; headphones/earphones; stuffed animal; portable/handheld Fan/heater; shower head; toothbrush/electric tooth brush; air freshener; candle holder; tissue box, pen/pencil; portable charger/wireless charger; phone case; headphone/earphone case; musical instrument; cassette; CD player, record player, and/or cassette player; picture frame; table top fire places; keychain; handbag; light structure; a ball; toy gun; mirror; hand wearable; case or storage; candy dispenser/gum ball machine; shoes; clothing; personal care tools; bound volume; lighter; ash tray; planter; bottle opener; jewelry; neck wearable; head or eye wearable; kitchen appliance; kitchenware; and any liquid-storing glass/container.
